(19) United States
(12) Patent Application Publication
(10) Pub. No.: US 2024/0345768 A1
(43) Pub. Date: Oct. 17, 2024

(54) SYSTEM AND METHODS FOR DETERMINING AN OPTIMAL DATA RELOCATION AT AN INDIVIDUAL READ DISTURB EVENT USING MULTIPLE WRITE STREAMS

(71) Applicant: SK Hynix NAND Product Solutions Corp. (dba Solidigm), Rancho Cordova, CA (US)

(72) Inventor: Paul Ruby, Folsom, CA (US)

(21) Appl. No.: 18/133,461

(22) Filed: Apr. 11, 2023

(51) Int. Cl. G06F 3/06

(52) U.S. Cl. CPC G06F 3/0659; G06F 3/0604; G06F 3/0679

(57) ABSTRACT

An indirect addressing memory system and related method for a storage device, including memory and processing circuitry, the processing circuitry to receive a read request from a host. The processing circuitry is to determine to relocate data at an address of the memory associated with the read request using a write stream of a plurality of write streams. The processing circuitry is then to cause the data to be relocated using the write stream. The plurality of write streams include a hot write stream, a warm write stream and a cold write stream. To cause the data to be relocated using the write stream, the processing circuitry is to determine the write stream based on an age of the data or an amount of invalid data in the data.

### TECHNICAL FIELD

The present disclosure is related to systems and methods for relocating data associated with an address to one of multiple write streams for an indirect addressing memory system.

### SUMMARY

In accordance with the present disclosure, systems and methods are provided for read disturb data relocation by using multiple write streams of an indirect addressing memory system, such as a solid state drive (SSD) device. The read disturb data relocation system and methods discussed herein reduce the likelihood of fragmentation of hot and cold data within memory of the system. Hot and cold data are discriminated on their respective frequency of being accessed or transferred by the read disturb data relocation system, such that hot data is accessed more frequently than cold data. Data fragmentation of hot and cold data may cause processing inefficiencies when managing, storing, or accessing data from memory (e.g., the indirect addressing memory) of the read disturb data relocation system. In order to better manage the data, the systems and methods disclosed herein use multiple write streams to separate hot data, warm data, and cold data when relocating data based on at least the age of each respective data within the read disturb data relocation system.

In some embodiments, the read disturb data relocation system (e.g., a solid state drive device) is provided with a memory and processing circuitry that are communicatively coupled to each other. The read disturb data relocation system may include any suitable hardware, software, or any combination thereof, which implement the features described herein. In some embodiments, the read disturb data relocation system is to receive a read request from a host and determine to relocate data at an address of the memory associated with the read request using a write stream of among a hot data write stream, a warm data write stream, and a cold data write stream. The read disturb data relocation system is then to cause the data to be relocated using the determined write stream. In some embodiments, the memory includes one of a solid state drive (SSD) memory, a flash memory, or a universal serial bus (USB) drive memory.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 shows an illustrative diagram of a system of a storage device with a processing circuitry and memory, in accordance with some embodiments of the present disclosure;

FIG. 2 shows an illustrative diagram of the storage device relocating data associated with a physical memory address accessed by a received read request, in accordance with some embodiments of the present disclosure;

FIG. 3 and FIG. 4 show flowcharts illustrating processes for relocating data in memory of a read disturb data relocation system, in accordance with some embodiments of the present disclosure; and

FIG. 5 and FIG. 6 show flowcharts illustrating processes for selecting the write stream from the plurality of write streams in a read disturb data relocation system, in accordance with some embodiments of the present disclosure.

### DETAILED DESCRIPTION

In accordance with the present disclosure, systems and methods are provided for read disturb data relocations using multiple write streams for indirect addressing memory systems (e.g., SSD devices). In particular, the present disclosure provides systems and methods for read disturb data relocation using multiple write streams in a storage device to improve the operational quality of the read disturb data relocation system (e.g., improve processing efficiency when multiple reads are received for hot data or cold data). In some embodiments, the multiple write streams include a hot data write stream, a warm data write stream, and a cold data write stream. Each write stream is located within the memory of the storage device and used during the read disturb data relocation to separate data based on their respective frequency to be accessed by the read disturb data relocation system. Each write stream is a continuous stream of stored data, and each write stream has a head (i.e., an initial physical memory address) which holds the first data of the write stream, and a tail, which is the next available physical memory address of the write stream for data to be relocated.

A read disturb data relocation system (e.g., a storage device) may include processing circuitry and memory. In some embodiments, the read requests are to be driven on a network bus or interface communicatively coupled to a host and the storage device. In some embodiments, processing circuitry of the read disturb data relocation system may include a processing unit (e.g., a processor), which may operate on a received read request. In some embodiments, read disturb data relocation may be completed by multiple processors, such that, for example, each processor is assigned to process a respective received read request.

In some embodiments, a processor of the processing circuitry may be a highly parallelized processor capable of handling high bandwidths of read requests or data relocation quickly (e.g., by starting simultaneous processing of new read requests or data relocations before completion of previous read requests or data relocations).

In memory, such as indirect addressing memory (e.g., an SSD), a read disturb may occur after a large amount of read operations are performed on a physical memory address of the same memory block. A read disturb may cause the stored data values of the physical memory address or data values of nearby physical memory addresses to change, which may cause undesirable results or errors.

In order to avoid errors related to read disturbs, the read disturb data relocation system may relocate data associated with physical memory addresses that are susceptible to read disturbs. The read disturb data relocation system may determine, by a processing circuitry, that a respective physical memory address is susceptible to a read disturb based on the number of read operations on that physical memory address compared to a preset number of read operations before the read disturb data relocation system may expect a read disturb. Once a physical memory address is determined to be susceptible to a read disturb, the data associated with the physical memory address is relocated to the tail of a write stream of other relocated data. In some implementations, the initial head of a write stream is determined to be in a memory block of available physical memory within the memory of the read disturb data relocation system. However, read disturb relocation using one write stream may cause data fragmentation of hot and cold data when hot data and cold data are relocated to the same write stream. In such an embodiment, this type of data fragmentation may cause processing inefficiencies when accessing data from memory.

Data relocation may improve the reliability of an indirect addressing memory system. However, it may result in data fragmentation of hot and cold data such that the read disturb data relocation system may relocate both hot and cold data into the same write stream. Data fragmentation where cold data is stored intermittently throughout memory blocks of hot data may cause performance issues of the read disturb data relocation system and reliability issues of the memory of the indirect addressing memory system.

Data fragmentation may also occur when the processing circuitry writes and overwrites at memory addresses in an indirect addressing memory. This is due to the use of logical memory addresses, which typically do not directly correspond to a physical memory address of the same value as the respective logical memory address. This type of logical memory addressing necessitates logical-to-physical memory address mappings in an indirection table in order to maintain a comprehensive mapping of logical memory addresses to physical memory addresses that are storing valid data.

When a host sends a write request with data and a logical memory address in which to store the data in an indirect addressing memory (e.g., an SSD) the read disturb data relocation system finds a next available first physical memory address in memory to write the data. The first physical memory address determined by the read disturb data relocation system does not necessarily correspond to the logical memory address sent by the host. An indirection table may be used in order to keep track of physical memory addresses that are mapped to a respective logical memory address. In some implementations the indirection table may include a valid bit, which indicates that a logical-to-physical memory address mapping is valid. Once data is written to memory, the indirection table is updated with a valid logical-to-physical address mapping. When the read disturb data relocation system receives a read request to access data at the same logical memory address, the read disturb data relocation system determines to access data from the first physical memory address based on the indirection table.

However, if a second write request is received by the read disturb data relocation system for the same logical memory address that was previously written to, the read disturb data relocation system determines a next available second physical memory address to write the data associated with the second write request. Therefore, the logical memory address that was previously written to is mapped to the second physical memory address. Once the logical-to-physical mapping is updated, the data that is stored at the first physical memory address remains there until it is overwritten or erased during garbage collection. In some implementations the first physical memory address is marked as being invalid or dirty by using a valid bit associated with the first physical memory address.

The storage device determines, by the processing circuitry, whether data at a physical memory address associated with the read request is to be relocated using one write stream among at least one hot data write stream, at least one warm data write stream, and at least one cold data write stream. The read disturb data relocation system may determine to relocate data at a physical memory address associated with the read request based on whether the physical memory address is susceptible to a read disturb. The read disturb data relocation system may determine that a respective physical memory address is susceptible to a read disturb based on the number of read operations on that physical memory address compared to a preset number of read operations before the read disturb data relocation system may expect a read disturb. When the read disturb data relocation system determines that the data of the address associated with the read request is to be relocated, the read disturb data relocation system causes the data to be relocated using the determined write stream.

In some embodiments, read disturb data relocation system causes the data to be relocated using the determined write stream. In some implementations read disturb data relocation system determines which write stream to relocate the data based on the age of the data at the physical memory address. The age of data at a respective physical memory address may be defined by the period of time in which the data at the respective physical memory address has been accessed, written to, or transferred. Read disturb data relocation system determines that the data at a physical memory address is to be relocated to one of a hot data write stream, a warm data write stream, and a cold data write stream, in respective order of increasing data age, based on the age of the data at the physical memory address. In some implementations, once a physical memory address is determined to be susceptible to a read disturb, the data associated with the physical memory address is relocated to the tail of one of the write streams (e.g., hot data write stream, warm data write stream, or cold data write stream).

In some embodiments the read disturb data relocation system and methods of the present disclosure may refer to a storage device system (e.g., an SSD storage system), which includes a storage device such as a solid-state drive device, which is communicatively coupled to a host by a network bus or interface.

An SSD is a data storage device that uses integrated circuit assemblies as memory to store data persistently. SSDs have no moving mechanical components, and this feature distinguishes SSDs from traditional electromechanical magnetic disks, such as, hard disk drives (HDDs) or floppy disks, which contain spinning disks and movable read/write heads. Compared to electromechanical disks, SSDs are typically more resistant to physical shock, run silently, have lower access time, and less latency. SSDs use indirect memory addressing, which stores data into a next available physical memory address and maps the next available physical memory address to the logical memory address within an indirection table.

Many types of SSDs use NAND-based flash memory which retains data without power and include a type of non-volatile storage technology. Quality of Service (QOS) of an SSD may be related to the predictability of low latency and consistency of high input/output operations per second (IOPS) while servicing read/write input/output (I/O) workloads. This means that the latency or the I/O command completion time needs to be within a specified range without having unexpected outliers. Throughput or I/O rate may also need to be tightly regulated without causing sudden drops in performance level.

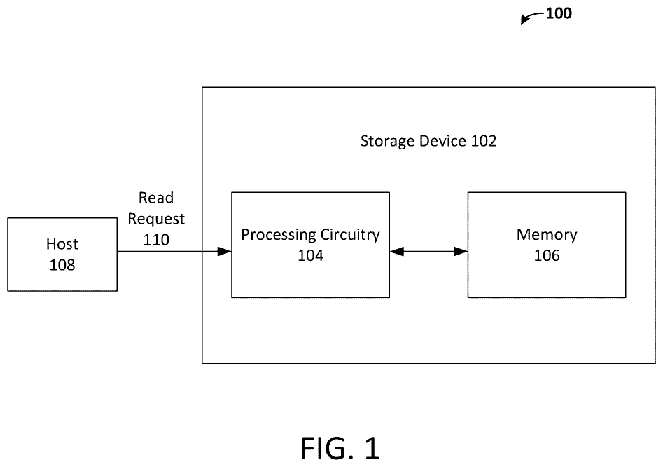

The subject matter of this disclosure may be better understood by reference to FIGS. 1-6.

FIG. 1 shows an illustrative diagram of a read disturb data relocation system 100 of a storage device 102 with a processing circuitry 104 and memory 106, in accordance with some embodiments of the present disclosure. In some embodiments, storage device 102 may be a solid-state storage device (e.g., a solid-state drive device). In some embodiments, processing circuitry 104 may include a processor or any suitable processing unit. In some embodiments, memory 106 may be non-volatile memory. It will be understood that the embodiments of the present disclosure are not limited to SSDs. For example, in some embodiments, the storage device 102 may include any suitable memory device with an indirect addressing memory system in addition to or in place of an SSD.

In some embodiments, the read disturb data relocation system 100 is configured to receive a read request 110, which is transmitted on a network bus or interface from an external source (e.g., a host 108). In some embodiments, the read disturb data relocation system 100 receives read requests (e.g., read request 110) from both internal and external sources of the storage device 102. There may also be a temporary memory (e.g., a cache or queue) disposed within the processing circuitry 104, such that the temporary memory is configured to store any outstanding read requests that are to be processed by the read disturb data relocation system 100.

Additionally, storage device 102 includes memory 106. In some embodiments, memory 106 includes any one or more of a non-volatile memory, such as flash memory, Universal Serial Bus (USB) drive memory, Phase Change Memory (PCM), a PCM and switch (PCMS), a Ferroelectric Random Access Memory (FeRAM), or a Ferroelectric Transistor Random Access Memory (FeTRAM), a Spin-Transfer Torque Random Access Memory (STT-RAM), a Resistive Random Access Memory (RRAM), a Memristor, and a Magnetoresistive Random Access Memory (MRAM), any other suitable memory, or any combination thereof. In some embodiments, processing circuitry 104 is communicatively coupled to memory 106 in order to store and access data at memory addresses within the memory. Memory 106 is memory that uses indirect memory addressing. Memory that uses indirect memory addressing memory typically includes an indirection table, which maps logical memory addresses (i.e., virtual memory addresses) from read requests or write requests to physical memory addresses from the memory (e.g., memory 106). In some implementations the indirection table may include a valid bit, which indicates that a logical-to-physical memory address mapping is valid. Once data is written to memory, the indirection table is updated with a valid logical-to-physical memory address mapping. When the read disturb data relocation system 100 receives a read request 110 to access data at a logical memory address, read disturb data relocation system 100 determines the physical memory address from which to access data based on the indirection table.

In some embodiments, a data bus interface is used to transport data associated with a physical memory address from memory 106. The data bus between the memory 106 and processing circuitry 104 provides a network bus for the reading or writing of data through memory 106. In some embodiments, the processor or processing unit of processing circuitry 104 may include a hardware processor, a software processor (e.g., a processor emulated using a virtual machine), or any combination thereof. The processor, also referred to herein as processing circuitry 104, may include any suitable software, hardware, or both for controlling the memory 106 and the processing circuitry 104. In some embodiments, the storage device 102 may further include a multi-core processor. Memory 106 may also include hardware elements for non-transitory storage of instructions, commands, or requests.

Storage devices (for example, SSD devices) may include one or more packages of non-volatile memory dies, where each die includes storage cells. In some embodiments, the storage cells are organized into pages, and pages are organized into blocks. Each storage cell can store one or more bits of information.

It will be understood that, while read disturb data relocation system 100 depicts an embodiment in which a storage device 102 is configured to relocate data associated with a physical memory address to one of multiple write streams in accordance with the present disclosure, any other suitable device can relocate data associated with a physical memory address to one of multiple write streams to avoid fragmentation of hot data, warm data, and cold data when the read disturb data relocation system 100 determines that the physical memory address is susceptible to a read disturb in a similar manner.

For purposes of clarity and brevity, and not by way of limitation, the present disclosure is provided in the context of read disturb data relocation to one of multiple write streams to avoid the fragmentation of hot data, warm data, and cold data when a read disturb is expected at a respective physical memory address, which provides the features and functionalities disclosed herein. The process of read disturb data relocation may be configured by any suitable software, hardware, or both for implementing such features and functionalities. Read disturb data relocation processing may be at least partially implemented in, for example, storage device 102 (e.g., as part of read disturb data relocation system 100, or any other suitable device on which efficiency may improve with read disturb data relocation). For example, for a solid-state storage device (i.e., storage device 102), relocating data from a physical memory address to one of multiple write streams, based on a read disturb event, may be implemented in processing circuitry 104.

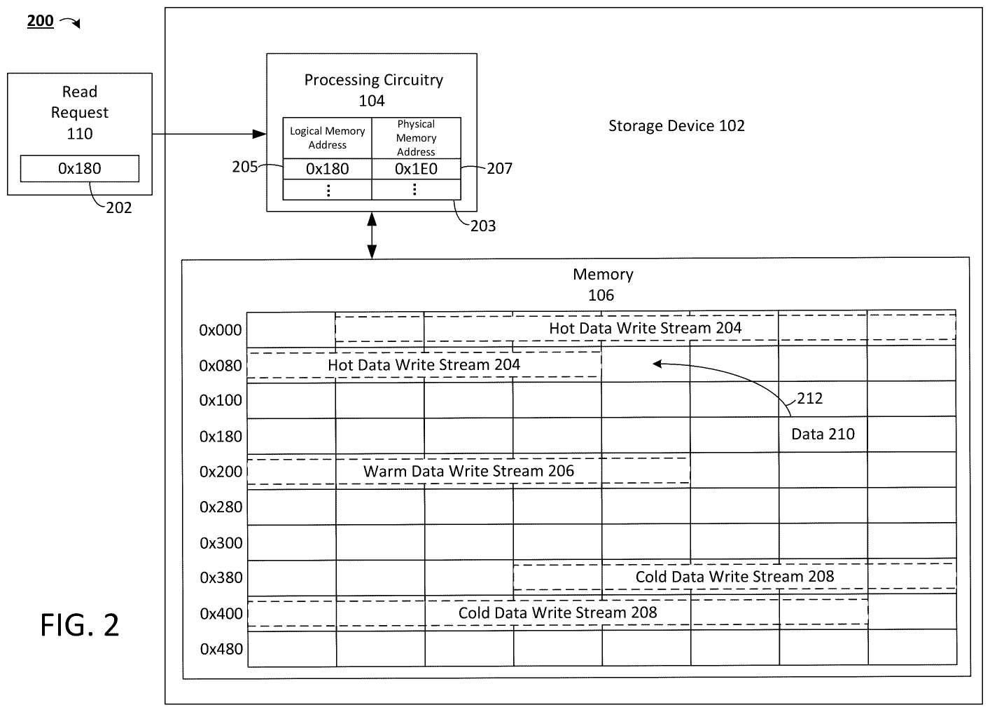

FIG. 2 shows an illustrative diagram of a read disturb data relocation system 200 with storage device 102 relocating data 210 associated with a physical memory address 207 accessed by a received read request 110, in accordance with some embodiments of the present disclosure. Although a certain configuration of data blocks of memory 106 are shown in FIG. 2, the number of data blocks per data line and size of each data block are not limited by the read disturb data relocation system 200 shown, where memory 106 may include any suitable number of data blocks per data line and any suitable size of each data block. In some embodiments, the physical memory address 207 is determined by read disturb data relocation system 200 by using indirection table 203 based on a corresponding mapped logical memory address 205. In some embodiments, the indirection table 203 may be stored on the processing circuitry 104, in memory 106 or stored in another additional memory in the storage device 102. In some embodiments, there may be more than one storage device, each storage device directed by a storage controller which stores and manages an indirection table for each storage device. In such embodiments, the processing circuitry of each storage device may be communicatively coupled to the storage controller to access the indirection table in order to perform read disturb data relocation, or the storage controller may contain multiple processors to perform read disturb data relocation for each storage device in parallel. The processing circuitry 104 is to be communicatively coupled to memory 106, such that the processing circuitry 104 may access data stored in each data block of memory 106.

In some embodiments, storage device 102 receives a read request 110, which includes a logical memory address 202 from which to read and access data. In some embodiments, the source of read request 110 is from another device (e.g., a host) located externally of storage device 102. In some embodiments, the source of request 110 may be located in storage device 102, such as an application programming interface (API). In some embodiments, storage device 102 is able to receive and process multiple read requests (e.g., request 110) by using temporary memory, such a cache, to store multiple read requests before the read requests are processed by read disturb data relocation system 200.

In some embodiments, read disturb data relocation system 200 determines a physical memory address 207 with the indirection table 203 in order to access data 210 stored at physical memory address 207. Once read disturb data relocation system 200 receives the read request 110 read disturb data relocation system 200 searches the indirection table 203 for a valid matching logical memory address (e.g., mapped logical memory address 205). When the read disturb data relocation system 200 determines the mapped logical memory address 205 which matches the received logical memory address 202 of the read request 110, read disturb data relocation system 200 may access the corresponding physical memory address 207 from the indirection table 203.

Memory 106 includes stored data 210 at physical memory address 207 as well as at least three write streams, including a hot data write stream 204, a warm data write stream 206, and a cold data write stream 208. Each write stream is initialized at a head data block and includes a continuous stream of data blocks of stored data until a tail of the write stream, which is the next available physical memory address for data to be relocated. When new data is relocated to the tail of a respective write stream, the tail is updated to the next available physical memory address following the previous tail of the respective write stream. Each of the write streams is located in a different area of memory 106. Hot data, warm data, and cold data are discriminated on their respective frequency of being accessed or transferred by read disturb data relocation system 200, such that hot data is accessed more frequently than cold data. Warm data may be used as an intermediate categorization of data between hot data and cold data in order to increase the granularity of organizing data.

In some embodiments, data 210 is located at a physical memory address 207, and when read disturb data relocation system 200 accesses data 210, read disturb data relocation system 200 determines that the number of read operations performed on the physical memory address 207 exceeds a preset number of read operations that corresponds to the likelihood of a read disturb to occur. In order to avoid a read disturb in memory 106, read disturb data relocation system 200 performs read disturb data relocation 212 using multiple write streams by relocating data 210 to the tail of the hot data write stream 204. Read disturb data relocation system 200 may determine the type of data (e.g., hot data, warm data, or cold data) based on at least the age of the data. In some embodiments, read disturb data relocation system 200 determines that data 210 is accessed frequently and is categorized as hot data. In some embodiments, the type of data (e.g., hot data, warm data, cold data) of a respective data block may also be determined by the amount of invalid data within the respective data block. In such embodiments, read disturb data relocation system 200 may determine that data within a data block with many invalid memory addresses of the data block is hot data, while data within a data block with few invalid memory addresses of the data block is cold data.

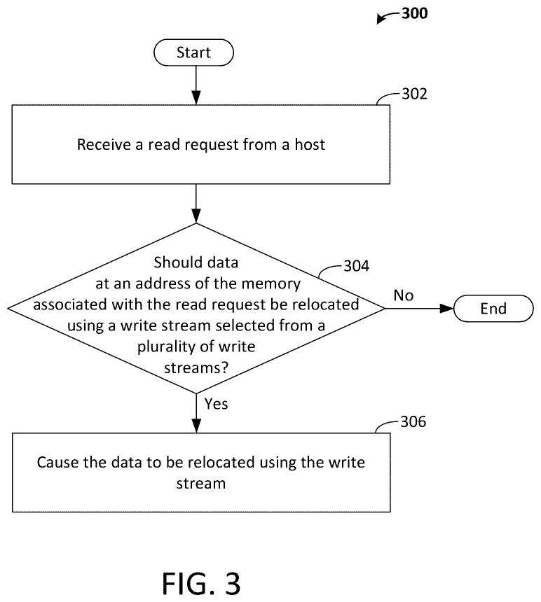

FIG. 3 shows a flowchart illustrating a process 300 for relocating data in memory of a read disturb data relocation system, in accordance with some embodiments of the present disclosure. In some embodiments, the referenced read disturb data relocation system, storage device, processing circuitry, memory, host, and read request may be implemented or represented as read disturb data relocation system 100, storage device 102, processing circuitry 104, memory 106, host 108, and read request 110, respectively. In some embodiments, process 300 can be modified by, for example, having steps rearranged, changed, added, and/or removed.

At step 302, the read disturb data relocation system receives a read request from a host. In some embodiments, the data is received, by the processing circuitry, a network bus or interface. The read request includes, at least, a logical memory address from which the read disturb data relocation system is to access data. In some implementations, read disturb data relocation system determines a physical memory address that corresponds to the received logical memory address by using an indirection table. In some embodiments, the read disturb data relocation system receives more than one read request. At least one of the received read requests may be stored in a memory, such as a cache or queue, or any form of volatile memory. In some embodiments, the processing circuitry may include a multi-core processor which can perform read disturb data relocation caused by one or more read requests. Once the read disturb data relocation system receives the read request from the host, the read disturb data relocation system determines whether the data at an address of the memory associated with the read request is to be relocated using a write stream of a plurality of write streams, at step 304.

At step 304, the read disturb data relocation system determines whether data at an address associated with the read request is to be relocated using a write stream of a plurality of write streams. The read disturb data relocation system may determine to relocate data at an address associated with the read request based on whether the memory at the address (i.e., the physical address) is susceptible to a read disturb. In some implementations the read disturb data relocation system determines that a respective physical memory address is susceptible to a read disturb based on the number of read operations on that physical memory address compared to a preset number of read operations before the read disturb data relocation system may expect a read disturb at that physical memory address. When the read disturb data relocation system determines that the data of the address associated with the read request is to be relocated, the read disturb data relocation system causes the data to be relocated using a write stream among the plurality of write streams, at step 306. When the read disturb data relocation system determines that the data at an address of the memory associated with the read request is not to be relocated, process 300 is completed.

At step 306, read disturb data relocation system causes the data to be relocated using the write stream. In some implementations read disturb data relocation system determines which write stream to relocate the data based on the age of the data at the physical memory address. The age of data may be defined by the period of time in which the data at the physical memory address has been accessed, written to, or transferred. Depending on the age of the data at the physical memory address, read disturb data relocation system determines that the data is to be relocated to one of a hot data write stream, a warm data write stream, and a cold data write stream, in respective order of increasing data ages. In some embodiments there is a data age range associated the warm data write stream including a minimum warm data age and a maximum warm data age. Therefore any data of a data age that is less than the minimum warm data age is determined, by the processing circuitry, to be hot data, and any data of data age that is greater than the maximum warm data age is determined, by the processing circuitry, to be cold data. In some implementations, once a physical memory address is determined to be susceptible to a read disturb, the data associated with the physical memory address is relocated to the tail of the determined write streams. In some embodiments, read disturb data relocation system determines the write stream to which the data at the physical memory address will be relocated based on the amount of invalid data within the data block. In such an implementation, the data block with more invalid data is determined to be relocated to the hot data write stream. Therefore, a data block with little to no invalid data may be determined to be relocated to the cold data write stream.

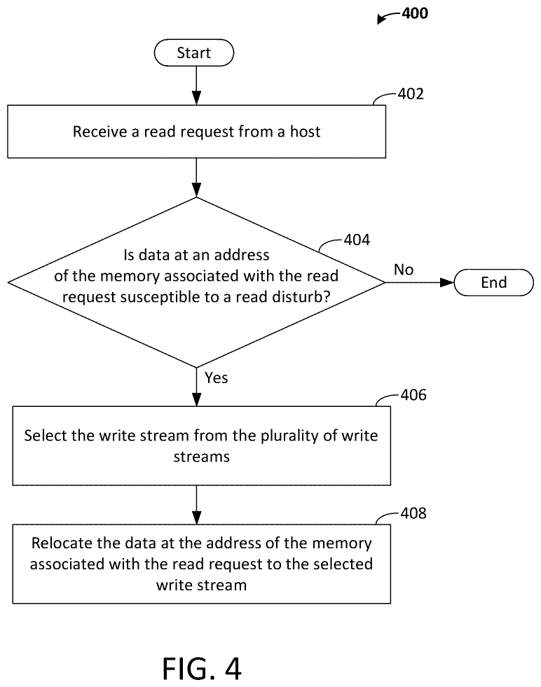

FIG. 4 shows a flowchart illustrating a process 400 for relocating data in memory of a read disturb data relocation system, in accordance with some embodiments of the present disclosure. In some embodiments, the referenced read disturb data relocation system, storage device, processing circuitry, memory, host, and read request may be implemented or represented as read disturb data relocation system 100, storage device 102, processing circuitry 104, memory 106, host 108, and read request 110, respectively. In some embodiments, process 400 can be modified by, for example, having steps rearranged, changed, added, and/or removed.

At step 402, the read disturb data relocation system receives a read request from a host. In some embodiments, the data is received through a network bus or interface. The read request includes, at least, a logical memory address from which the read disturb data relocation system is to access data. In some implementations, read disturb data relocation system determines a physical memory address that corresponds to the received logical memory address by using an indirection table. In some embodiments, the read disturb data relocation system receives more than one read request. At least one of the received read requests may be stored in a memory, such as a cache or queue, or any form of volatile memory. In some embodiments, the processing circuitry may include a multi-core processor which can perform read disturb data relocation caused by one or more read requests. Once the read disturb data relocation system receives the read request from the host, the read disturb data relocation system determines whether the data at an address of the memory associated with the read request is susceptible to a read disturb, at step 404.

At step 404, the read disturb data relocation system determines whether data at an address associated with the read request is susceptible to a read disturb. In some implementations the read disturb data relocation system determines that a respective physical memory address is susceptible to a read disturb based on the number of read operations on that physical memory address compared to a preset number of read operations before the read disturb data relocation system may expect a read disturb at that physical memory address. When the number of read operations on the physical memory address, including the received read request from step 402, exceeds the preset number of read operations, the read disturb data relocation system determines that the data at the physical memory address is to be relocated using a write stream among at least one hot data write stream, at least one warm data write stream, and at least one cold data write stream, at step 406. When the read disturb data relocation system determines that the data at an address of the memory associated with the read request is not to be relocated, process 400 is completed.

At step 406, the read disturb data relocation system selects the write stream from the plurality of write streams. The write streams may include at least one hot data write stream, at least one warm data write stream, and at least one cold data write stream. In some embodiments, the write stream may be selected based on the age of the data at the memory address associated with the read request. The age of data may be defined by the period of time in which the data at the physical memory address has been accessed, written to, or transferred. Depending on the age of the data at the physical memory address, read disturb data relocation system determines that the data is to be relocated to one of a hot data write stream, a warm data write stream, and a cold data write stream, in respective order of increasing data ages. In some embodiments, the write stream may be selected based on the amount of invalid data within the data at the memory address associated with the read request. Once the write stream is selected by the read disturb data relocation system, the read disturb data relocation system causes the data at the address of the memory associated with the read request to be relocated to the selected write stream.

At step 408, read disturb data relocation system causes the data to be relocated using the write stream. In some embodiments there is a data age range associated the warm data write stream including a minimum warm data age and a maximum warm data age. Therefore any data of a data age that is less than the minimum warm data age is determined, by the processing circuitry, to be hot data, and any data of data age that is greater than the maximum warm data age is determined, by the processing circuitry, to be cold data. In some implementations, once a physical memory address is determined to be susceptible to a read disturb, the data associated with the physical memory address is relocated to the tail of the determined write streams. In some embodiments, read disturb data relocation system determines the write stream to which the data at the physical memory address will be relocated based on the amount of invalid data within the data block. In such an implementation, the data block with more invalid data is determined to be relocated to the hot data write stream. Therefore, a data block with little to no invalid data may be determined to be relocated to the cold data write stream.

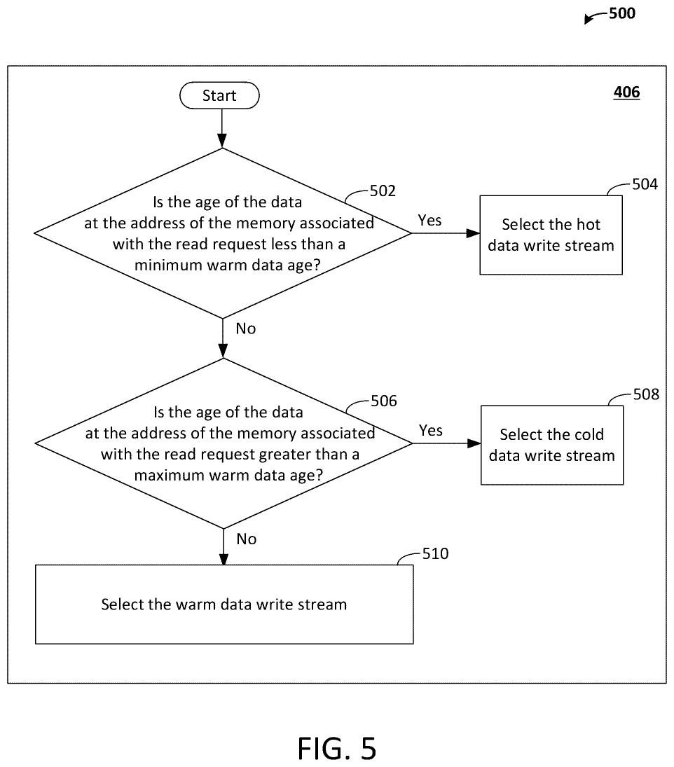

FIG. 5 shows a flowchart illustrating a process 500 for selecting the write stream from the plurality of write streams in a read disturb data relocation system, in accordance with some embodiments of the present disclosure. In some embodiments, step 406 of FIG. 4 may be implemented by the steps shown in process 500. In some embodiments, the referenced read disturb data relocation system, storage device, processing circuitry, memory, host, and read request may be implemented or represented as read disturb data relocation system 100, storage device 102, processing circuitry 104, memory 106, host 108, and read request 110, respectively. In some embodiments, process 500 can be modified by, for example, having steps rearranged, changed, added, and/or removed.

At step 502, the read disturb data relocation system determines whether the age of the data at the address of the memory associated with the read request is less than a minimum warm data age. In some implementations the minimum warm data age is determined by a minimum age of any data within a warm data write stream. In some implementations, the minimum warm data age is configured by a preset warm data age value. When the age of the data associated with the read request is less than the minimum warm data age, the read disturb data relocation system selects the hot data write stream, at step 504. If the age of the data at the address of the memory associated with the read request is greater than a minimum warm data age, the read disturb data relocation system then determines whether the age of the data at the address of the memory associated with the read request is greater than a maximum warm data age, at step 506.

At step 504, the read disturb data relocation system selects the hot data write stream. In some implementations, the read disturb data relocation system determines the physical memory address of the tail of the hot data write stream when determining the physical memory location to relocate the data at the memory address associated with the read request.

At step 506, the read disturb data relocation system determines whether the age of the data at the address of the memory associated with the read request is greater than a maximum warm data age. In some implementations the maximum warm data age is determined by a maximum age of any data within a warm data write stream. In some implementations, the maximum warm data age is configured by a preset warm data age value. When the age of the data associated with the read request is greater than the maximum warm data age, the read disturb data relocation system selects a cold data write stream, at step 508. If the age of the data at the address of the memory associated with the read request is less than a maximum warm data age, the read disturb data relocation system selects a warm data write stream, at step 510.

At step 508, the read disturb data relocation system selects the cold data write stream. In some implementations, the read disturb data relocation system determines the physical memory address of the tail of the cold data write stream when determining the physical memory location to relocate the data at the memory address associated with the read request.

At step 510, the read disturb data relocation system selects the warm data write stream. In some implementations, the read disturb data relocation system determines the physical memory address of the tail of the warm data write stream when determining the physical memory location to relocate the data at the memory address associated with the read request.

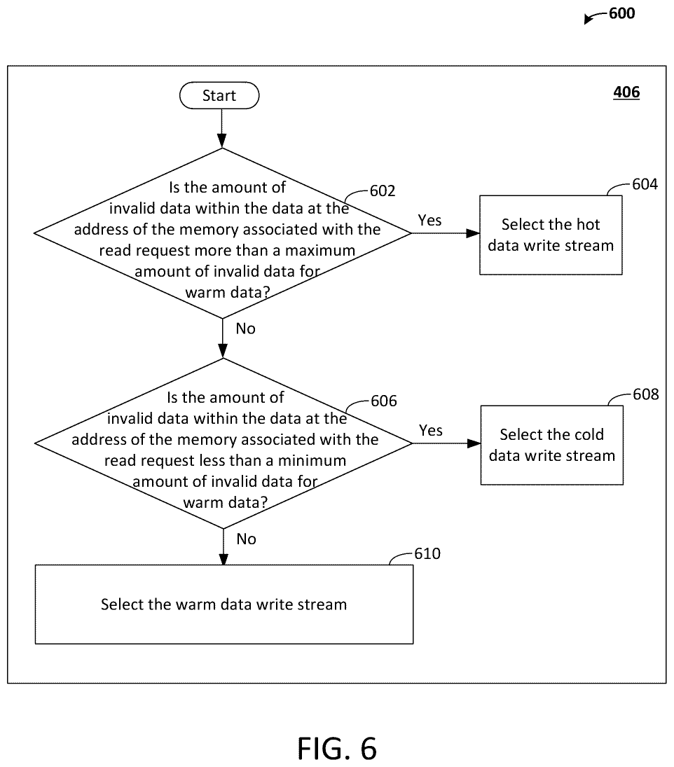

FIG. 6 shows a flowchart illustrating a process 600 for selecting the write stream from the plurality of write streams in a read disturb data relocation system, in accordance with some embodiments of the present disclosure. In some embodiments, step 406 of FIG. 4 may be implemented by the steps shown in process 600. In some embodiments, the referenced read disturb data relocation system, storage device, processing circuitry, memory, host, and read request may be implemented or represented as read disturb data relocation system 100, storage device 102, processing circuitry 104, memory 106, host 108, and read request 110, respectively. In some embodiments, process 600 can be modified by, for example, having steps rearranged, changed, added, and/or removed.

At step 602, the read disturb data relocation system determines whether the amount of invalid data within the data at the address of the memory associated with the read request is more than a maximum amount of invalid data for warm data. In some implementations, the maximum amount of invalid data for warm data is configured by a preset maximum amount of invalid data for warm data. When the amount of invalid data within the data associated with the read request is more than the maximum amount of invalid data for warm data, the read disturb data relocation system selects the hot data write stream, at step 604. If the amount of invalid data within the data at the address of the memory associated with the read request is less than the maximum amount of invalid data for warm data, the read disturb data relocation system then determines whether the amount of invalid data within the data at the address of the memory associated with the read request is less than a minimum amount of invalid data for warm data, at step 606.

At step 604, the read disturb data relocation system selects the hot data write stream. In some implementations, the read disturb data relocation system determines the physical memory address of the tail of the hot data write stream when determining the physical memory location to relocate the data at the memory address associated with the read request.

At step 606, the read disturb data relocation system determines whether the amount of invalid data within the data at the address of the memory associated with the read request is less than a minimum warm data. In some implementations, the minimum amount of invalid data for warm data is configured by a preset minimum amount of invalid data for warm data. When the amount of invalid data within the data associated with the read request is less than the minimum amount of invalid data for warm data, the read disturb data relocation system selects a cold data write stream, at step 608. If the amount of invalid data within the data at the address of the memory associated with the read request is greater than a minimum amount of invalid data for warm data, the read disturb data relocation system selects a warm data write stream, at step 610.

At step 608, the read disturb data relocation system selects the cold data write stream. In some implementations, the read disturb data relocation system determines the physical memory address of the tail of the cold data write stream when determining the physical memory location to relocate the data at the memory address associated with the read request.

At step 610, the read disturb data relocation system selects the warm data write stream. In some implementations, the read disturb data relocation system determines the physical memory address of the tail of the warm data write stream when determining the physical memory location to relocate the data at the memory address associated with the read request.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

1. A system, comprising;
memory; and
processing circuitry to:
receive a read request from a host,
determine that data at an address of the memory associated with the read request is susceptible to a read disturb;
in response to the determination that the data at the address of the memory associated with the read request is susceptible to a read disturb, select a write stream from a plurality of write streams based on a characteristic of the data, and
cause the data to be relocated using the write stream.

2. The system of claim 1, wherein the memory comprises indirect addressing memory.

3. The system of claim 2, wherein the memory comprises solid state drive memory.

4. The system of claim 2, wherein the memory comprises flash memory.

5. The system of claim 2, wherein the memory comprises Universal Serial Bus drive memory.

6. The system of claim 1, wherein the write stream is selected based on an age of the data.

7. The system of claim 1, wherein the write stream is selected based on an amount of invalid data in the data.

8. The system of claim 1, wherein the plurality of write streams comprises a hot data write stream, a warm data write stream, and a cold data write stream.

9. A method for relocating data in memory of an indirect addressing memory system, the method comprising:
receiving, by processing circuitry, a read request from a host,
determining, by the processing circuitry, that data at an address of a memory associated with the read request is susceptible to a read disturb;
in response to the determining that the data at the address of the memory associated with the read request is susceptible to a read disturb, selecting a write stream from a plurality of write streams based on a characteristic of the data, and
causing, by the processing circuitry, the data to be relocated using the write stream.

10. The method of claim 9, wherein determining that data at an address of a memory associated with the read request is susceptible to a read disturb comprises determining that data at an address of a solid-state drive memory associated with the read request is susceptible to a read disturb.

11. The method of claim 9, wherein determining that data at an address of a memory associated with the read request is susceptible to a read disturb comprises determining that data at an address of a flash memory associated with the read request is susceptible to a read disturb.

12. The method of claim 9, wherein determining that data at an address of a memory associated with the read request is susceptible to a read disturb comprises determining to relocate that data at an address of a Universal Serial Bus drive memory associated with the read request is susceptible to a read disturb.

13. The method of claim 9, wherein causing the data to be relocated using the write stream comprises selecting the write stream based on an age of the data.

14. The method of claim 9, wherein causing the data to be relocated using the write stream comprises selecting the write stream based on an amount of invalid data in the data.

15. The method of claim 9, wherein selecting a write stream of a plurality of write streams based on a characteristic of the data, wherein the plurality of write streams comprise a hot write stream, a warm write stream, and a cold write stream.

16. A non-transitory computer-readable medium having non-transitory computer-readable instructions encoded thereon that, when executed by processing circuitry, cause the processing circuitry to:
receive a read request from a host,
determine that data at an address of a memory associated with the read request is susceptible to a read disturb;
in response to the determination that the data at the address of the memory associated with the read request is susceptible to a read disturb, select a write stream from a plurality of write streams based on a characteristic of the data, and
cause the data to be relocated using the write stream.

17. The non-transitory computer-readable medium of claim 16, wherein the memory comprises indirect addressing memory.

18. The non-transitory computer-readable medium of claim 17, wherein the memory comprises solid state drive memory.

19. The non-transitory computer-readable medium of claim 17, wherein the memory comprises flash memory.

20. The non-transitory computer-readable medium of claim 17, wherein the memory comprises Universal Serial Bus drive memory.

21. The non-transitory computer-readable medium of claim 16, wherein the write stream is selected based on an age of the data.

22. The non-transitory computer-readable medium of claim 16, wherein the write stream is selected based on an amount of invalid data in the data.

23. The non-transitory computer-readable medium of claim 16, wherein the plurality of write streams comprises a hot write stream, a warm write stream, and a cold write stream.

24. The system of claim 1, wherein to determine that data at an address of the memory associated with the read request is susceptible to a read disturb, the processing circuitry is to determine that data at an address of the memory associated with the read request is susceptible to a read disturb based on a number of read operations performed on the address of the memory associated with the read request compared to a preset number of read operations performed on a memory address before expecting a read disturb.
